(19) United States
(12) Patent Application Publication
(10) Pub. No.: US 2009/0053544 A1
(43) Pub. Date: Feb. 26, 2009

(54) METHOD OF STARCH REDUCTION IN WALLBOARD MANUFACTURING AND PRODUCTS MADE THEREFROM

(75) Inventor: Gopalakrishnan Sethuraman, Charlotte, NC (US)

Correspondence Address: Kregg Brooks, Suite 3500, 200 West Madison Street, Chicago, IL, 60625, US

(73) Assignee: National Gypsum Properties, LLC, Charlotte, NC (US)

(21) Appl. No.: 12/196,750

(22) Filed: Aug. 22, 2008

Related U.S. Application Data
(60) Provisional application No. 60/957,385, filed on Aug. 22, 2007.

(51) Int. Cl. B32B 13/12; B32B 27/00; C08K 3/30

(52) U.S. Cl. 428/522; 156/39; 524/2

(57) ABSTRACT

A gypsum composition for use as a wallboard core contains stucco, water, a styrene acrylic or acrylic hybrid copolymer, and a reduced amount of starch. A finished wallboard using this composition has similar properties, including compressive strength and paper core bond strength of a finished board, to wallboards made from compositions having higher quantities of starch. A method for producing such a composition is shown, the method requiring mixing of stucco and pulp water in a pin mixer, with the addition of starch and the styrene acrylic or acrylic hybrid copolymer.

This application claims priority to co-pending U.S. Provisional Application Ser. No. 60/957,835, filed Aug. 22, 2007, which is hereby incorporated by reference.

### BACKGROUND

To be commercially profitable, gypsum products, such as wallboard, are typically manufactured by continuous high speed processes. Typically, wallboard consists essentially of a gypsum core sandwiched between and bonded to two sheets of facing material and is predominately made up of natural gypsum (calcium sulfate dihydrate). Manufacturers mine and transport gypsum to a mill in order to dry it, crush/grind it and calcine it to yield stucco. The reaction for the calcination process is characterized by the following equation:

CaSO₄.2H₂O+heat→CaSO₄.½H₂O+1½H₂O

This equation shows that calcium sulfate dihydrate plus heat yields calcium sulfate hemihydrate (stucco) plus water vapor. This process is conducted in a calciner, of which there are several types known in the art. The stucco can contain one of two forms of calcium sulfate hemihydrate: the α-hemihydrate form and the β-hemihydrate form. These two types of stucco are often produced by different means of calcination. While the β-hemihydrate form is normally used due to its lower cost, either type of calcium sulfate hemihydrate is suitable for use.

Calcined gypsum (stucco) has the valuable property of being chemically reactive with water and will “set” rather quickly when the two are mixed together. This setting reaction reverses the above-described stucco chemical reaction performed during the calcination step. The reaction proceeds according to the following equation:

CaSO₄.½H₂O+1½H₂O→CaSO₄.2H₂O+heat

In this reaction, the calcium sulfate hemihydrate is rehydrated to its dihydrate state over a fairly short period of time. The actual time required for this setting reaction generally depends upon the type of calciner employed and the type of gypsum rock that is used. The reaction time can be controlled to a certain extent by the use of additives such as accelerators and retarders.

In known manufacturing processes for gypsum wallboard, the setting reaction is facilitated by premixing dry and wet ingredients in a mixing apparatus, such as a pin mixer. The dry ingredients can include, but are not limited to, any combination of calcium sulfate hemihydrate (stucco), fiberglass, accelerator, and in some cases natural polymer (i.e., starch). The wet ingredients can comprise of many components, including but not limited to, a mixture of water, paper pulp, and potash (hereinafter, collectively referred to as a “pulp paper solution”). The pulp paper solution provides a significant portion of the water that forms the gypsum slurry of the core composition of the wallboard. The dry ingredients and the pulp paper solution contain the basic chemical components of a piece of wallboard.

Conventional methods of preparing gypsum wallboard are well known to those skilled in the art. For example, the dry ingredients and pulp paper solution can be mixed together in a pin mixer. In this manner, the dry ingredients and pulp paper solution create a fluid mixture or “slurry.” The slurry is discharged from the mixer through the mixer's outlet chute or “boot” which spreads the slurry on a moving, continuous bottom facing material. After the slurry is discharged on the moving, continuous bottom facing material, a moving, continuous top facing material is placed on the slurry and the bottom facing material, so that the slurry is positioned in between the top and bottom facing materials to form the board. Where necessary, the board can pass through a forming station which forms the wallboard to the desired thickness and width. The board travels along a belt line for several minutes, during which time the rehydration reaction occurs and the board stiffens. The boards are cut into a desired length and fed into a large, continuous kiln for drying. During the drying process, the excess water (free water) is evaporated from the gypsum core while the chemically bound water is retained in the newly formed gypsum crystals.

While conventional gypsum wallboard products have many advantages, it has also long been desired to reduce the cost of manufacturing gypsum wallboard. One method of reducing the cost of manufacturing gypsum wallboard has been to reduce the amount of water used in the manufacturing of the wallboard. Reduction in water reduces the amount of free water left in the wallboard after the setting reaction. A lower amount of free water left in the wallboard results in less drying energy being expended to remove the free water, which in turn saves energy costs associated with drying wallboard (i.e., the fuel cost associated with operating a kiln to dry the wallboard is reduced). However, reducing water negatively impacts the manufacturing process by reducing the slurry fluidity, increasing board weight, adversely affecting the paper to core bond, and decreasing the compressive strength of the board. Wallboard gets its strength from the formation of crystals of calcium sulfate dihydrate during the rehydration process. The reduction of water results in some of the calcium sulfate hemihydrate not being rehydrated to its dihydrate state.

To ensure that the slurry remains fluid and the weight of the board is not increased, gypsum wallboard is often produced by incorporating aqueous foam into the stucco slurry. The foam comprises foam cells/bubbles that create air pockets in the gypsum core of the wallboard, as the slurry sets. Thus, the core density and the overall weight of the wallboard can be controlled by incorporating aqueous foam into the slurry. The foam usually is prepared using foam water, a foaming solution (i.e., soap), and air in any number of mechanical foam generation devices. As the amount of water used in the slurry decreases, the volume of aqueous foam is increased to maintain desired board weights and thickness. While foam can be used for these purposes, the use of aqueous foam has the detrimental effect of reducing the strength of the produced wallboard.

The increased level of foam produces an increased number of foam cells at the paper core interface. Wallboard gets its strength from the formation and the interlocking of crystals of calcium sulfate dihydrate that form during the rehydration process. At the paper core interface, these crystals of calcium sulfate dihydrate interlock with the fibers of the facing materials to form the paper to core bond. While “paper core interface” and “paper to core bond” is used throughout this disclosure, it is appreciated that any facing material can be used to sandwich the gypsum core. Thus, the term “paper core interface” will refer to the interface between the core and any facing material used and the term “paper to core bond” will refer to the bond formed between the core and any facing material used. The presence of foam cells at the paper to core interface causes a decrease in the strength of the paper to core bond, because the foam cells at the paper core interface prevent a uniform paper to core bond from forming.

To strengthen the paper to core bond and the compressive strength of the wallboard, it is known that natural polymers, such as acid modified starches, can be added to the dry ingredients and/or paper pulp solution. Starch gels during the drying of wallboard and is carried to the paper core interface by the evaporating water. The presence of the gelled starch at the paper core interface causes a stronger bond between the facing material and the core to form. While such natural polymers strengthen the paper to core bond to acceptable levels for wallboards containing foam, such natural polymers are expensive and add cost in manufacturing gypsum wallboard. Moreover, such natural polymers are normally chemically modified (i.e., acid modified starches) which in turn leads to impurities (i.e., chloride or sodium) being introduced into the finished wallboard. Such impurities can yield defective wallboards. This invention discusses ways to reduce the amount of natural polymers used in order to improve the quality of wallboard produced, while reducing the cost of producing wallboard and still maintaining sufficient overall board strength and paper to core bond strength.

### SUMMARY

In one embodiment of the invention, a gypsum board may be formed from a core composition containing water, calcium sulfate hemihydrate, starch in an amount between 0 to 12 pounds per 1000 manufacturing square feet, and at least one styrene acrylic or acrylic hybrid copolymer in an amount between 0.25 and 1 pound per 1000 manufacturing square feet of the slurry. In one embodiment, a board formed from this composition may have equivalent or better nail pull strength than a comparable board with no styrene acrylic or acrylic hybrid copolymer and at least 2 lbs more of starch. A board according to this embodiment may also have equivalent or better humidified paper core bond integrity than such a comparable board. In a further embodiment, the acrylic hybrid copolymer may be a silicone hybrid copolymer.

In another embodiment of the invention, a method for producing a wallboard core slurry in a mixer having a hopper and a pulp waterline comprises adding stucco and a dry ingredient through the hopper, adding pulp water and a wet ingredient through the pulp waterline, adding between 0 to 12 pounds per 1,000 manufacturing square feet of a natural polymer, such as starch, and adding at least one styrene acrylic copolymer or acrylic hybrid copolymer, and forming a gypsum slurry by mixing the aforementioned ingredients in the mixer. The styrene acrylic or acrylic hybrid copolymer may be a silicone hybrid copolymer, and may be added in an amount between 0.25 and pound per 1,000 manufacturing square feet of the slurry.

In a further embodiment, the mixer may have also have a gauging waterline, and gauging water may be added to the mixer through the gauging waterline to be mixed with the slurry. In another further embodiment, a foam waterline may be added, and foam may be added to be mixed in the slurry through the foam waterline. The styrene acrylic or acrylic hybrid copolymer may be added to the mixer with any of the pulp water, gauging water, or foam in the aforementioned embodiments.

In a further embodiment, the mixed slurry may be formed and set into a gypsum wallboard, the wallboard having equivalent or better nail pull strength as a comparable board made without adding the styrene acrylic or acrylic hybrid copolymer and adding 2 pounds per 1,000 manufacturing square feet more starch. In an alternate embodiment, the mixed slurry may be formed and set into a paper faced board having equivalent or better humidified paper core bond integrity as a comparable paper faced board made without adding the styrene acrylic or acrylic hybrid copolymer and adding 2 pounds per 1,000 manufacturing square feet more starch.

### DESCRIPTION OF THE DRAWINGS

FIG. 1 is a front view of an exemplary pin mixer.

### DETAILED DESCRIPTION

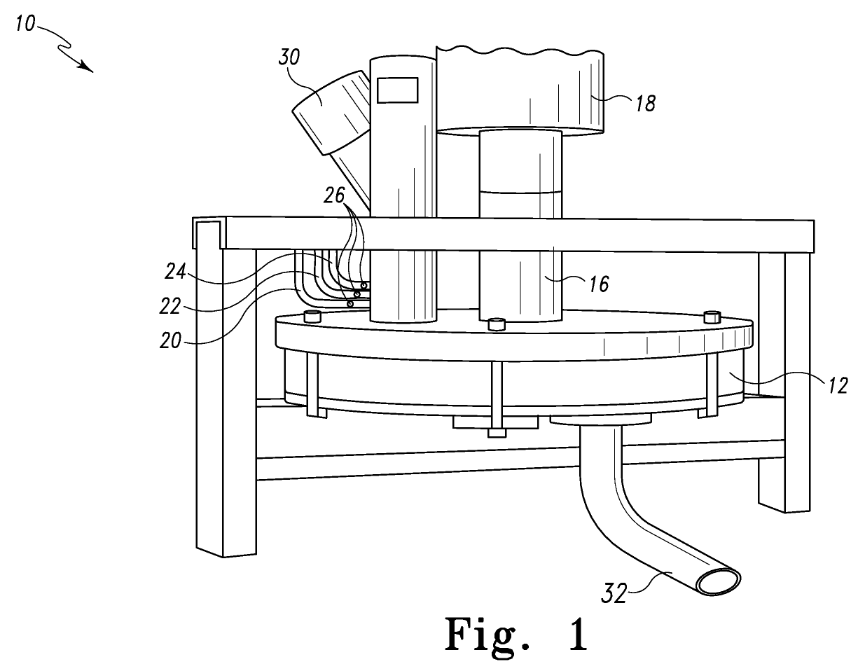

As discussed, a method for manufacturing gypsum wallboard includes pre-mixing dry ingredients and a pulp paper solution in a mixing apparatus to create the gypsum slurry. FIG. 1 shows a front perspective view of an exemplary pin mixer 10 that can be used to mix the dry ingredients with the pulp paper solution to produce the stucco slurry. As shown in FIG. 1, pin mixer 10 has a shell 12 that houses a plurality of pins (not shown). A motor 18 operates to turn a rotor 16, which in turn spins the pins in shell 12 to mix the ingredients. Pin mixer 10 also has hopper 30 that allows for the dry ingredients to be deposited into pin mixer 10. Pulp waterline 20 for adding the pulp paper solution, gauging waterline 22 for adding additional water, and foam waterline 24 for adding foam are all connected to mixer 10 and allow for the pulp paper solution, water, and a foam solution to be added to the pin mixer and the gypsum slurry. Prior to being fed to the pin mixer through the foam waterline 24, the foam solution is created by any number of foam generation devices known in the art. Each of the waterlines 20, 22, and 24 can have an inlet 26 (or multiple inlets) that allows for other components to be added to the waterlines. Similarly, the foam generation device can be equipped with inlets that allow for components to be added directly to the foam solution as it is generated.

The slurry is deposited on a continuous moving bottom facing material (not shown) through slurry discharge 32, which can be a boot or other suitable conduit (e.g., flexible hosing or pipes). It will be appreciated that any number of facing materials can be used to create the gypsum wallboard, including but not limited to paper or styrofoam. Slurry discharge 32 may also be equipped with inlets (not pictured) that allows for other ingredients to be added to the slurry as it passes through the slurry discharge 32. It will be appreciated that slurry discharge 32 can have any number of inlets that allow for the addition of such ingredients. While FIG. 1 shows an exemplary pin mixer used in a gypsum product manufacturing process, it will be appreciated that any number of suitable mixers exist for forming the slurry and that FIG. 1 is only provided for the sake of discussion.

As briefly discussed above, a natural polymer, such as a starch, can be added to the pulp paper solution, the dry ingredients or to both the pulp paper solution and dry ingredients. While such natural polymers increase the overall strength of the board and strengthen the paper to core bond, such natural polymers also increase the cost of the production of wallboard and typically introduce impurities into the produced wallboard. The use of such natural polymers can be reduced by adding styrene acrylic copolymers or acrylic hybrid copolymers to the slurry. These additives can be added in any number of ways to the slurry, including without limitation, being placed in an emulsion and pumped in a diluted or undiluted form into pulp waterline 20, gauging waterline 22 or foam waterline 24 through inlets 26. Alternatively, such additives can already be part of the dry ingredients, part of the pulp paper solution or part of both the pulp paper solution and dry ingredients.

Suitable styrene acrylic copolymers or acrylic hybrid copolymers that can be added to the slurry in order to reduce the amount of natural polymer used include, but are not limited to, styrene butadiene rubber and silicone hybrid polymers. Exemplary silicone hybrid polymers include, but are not limited to, YC-50, RC-902 and AB-3244, which are all available from Saiden Technologies. While specific examples of silicone hybrid polymer are discussed in this disclosure, it will be appreciated that other styrene acrylic copolymers or acrylic hybrid copolymers, in either liquid or solid form, can be used and that these examples are not limiting in nature.

When styrene acrylic copolymers or acrylic hybrid copolymers are added in the amount of about 0.25 pounds per 1,000 square feet to about 1 pound per 1,000 square feet to the wallboard slurry, the amount of natural polymer used in the slurry can be reduced up to about 60% without detrimentally impacting the overall strength and paper to core bond of the produced wallboard. By reducing the amount of natural polymer used, a manufacturer can reduce the cost of manufacturing gypsum wallboard and increase the quality of the boards produced. The quality is increased because the reduction of natural polymers reduces the impurities (i.e., chloride or sodium) that are introduced into the wallboard by the use of such natural polymers.

The following examples are included to demonstrate some of the formulations and techniques that can be used to reduce the amount of natural polymers used by adding styrene acrylic copolymers or acrylic hybrid copolymers. Those of ordinary skill in the art will appreciate that many changes can be made to the following sample slurry compositions and formulation techniques, while still obtaining a like or similar result without departing from the spirit and scope of this disclosure.

### Sample Slurry Formulations

The humidified paper core bond integrity and compressive (nail-pull) strength of a series of wallboard samples containing a styrene acrylic copolymer or acrylic hybrid copolymer and reduced natural polymer levels were compared with samples containing the normal amount of starch and no styrene acrylic copolymer or acrylic hybrid copolymer. The comparisons demonstrate that the reduction of natural polymers used in the wallboard manufacturing process can be obtained without detrimentally impacting the overall strength of wallboard or the strength of the paper to core bond. The humidified paper core bond integrity is a measure of the percent of the facing material able to be peeled away from the core after being subjected to a high humidity environment (e.g., an environment with 90% humidity and a 90° F. temperature) for a set period of time.

Table I shows an exemplary slurry formulation in pounds per 1,000 square feet for ½ inch thick wallboard. Table II shows an exemplary slurry formulation in pounds per 1,000 square feet for ⅝ inch thick wallboard. It is understood by one skilled in the art that enough of each component is added to produce dry boards with weights about 1,400 to about 1,700 pounds per 1,000 square feet for a ½ inch thick wallboard and at least about 2,200 pounds per 1,000 square feet for a ⅝ inch thick wallboard. The term “additive” refers generically, in all the following tables, to the styrene acrylic copolymer or acrylic hybrid copolymer that is used. In addition, the term “msf” refers to the unit of 1,000 square feet in all the following tables.

TABLE I
Slurry Formulation for ½ Inch Thick Board

| | Control | Samples |
|---|---|---|
| Materials | lbs/msf | lbs/msf |
| Stucco | 1188 ± .5% | 1188 ± .5% |
| Foam Water | 301 ± .5% | 301 ± .5% |
| Gauging Water | 532 ± .5% | 532 ± .5% |
| Pulp (water and paper) | 170 ± .5% | 170 ± .5% |
| Soap | 0.5-0.8 ± .5% | 0.5-0.8 ± .5% |
| Water dispersant | 3.27 ± .5% | 3.27 ± .5% |
| Starch | 14 ± .5% | 0-12 ± .5% |
| Accelerator* | 6.2 ± .5% | 6.2 ± .5% |
| Additive | 0 ± .5% | .4-.775 ± .5% |
| Wax Emulsion | 56 ± .5% | 56 ± .5% |
| Potash | 2.00 ± .5% | 2.00 ± .5% |
| Retarder | 0.1 ± .5% | 0.1 ± .5% |

TABLE II
Slurry Formulation for ⅝ Inch Thick Board

| | Control | Samples |
|---|---|---|
| Materials | lbs/msf | lbs/msf |
| Stucco | 1935 ± .5% | 1935 ± .5% |
| Foam Water | 405 ± .5% | 405 ± .5% |
| Gauging Water | 736 ± .5% | 736 ± .5% |
| Pulp (water and paper) | 201 ± .5% | 201 ± .5% |
| Soap | 0.5-0.8 ± .5% | 0.5-0.8 ± .5% |
| Water dispersant | 4.51 ± .5% | 4.51 ± .5% |
| Starch | 9 ± .5% | 0-7 ± .5% |
| Fiberglass | 4.18 ± .5% | 4.18 ± .5% |
| Accelerator* | 3.5 ± .5% | 3.5 ± .5% |
| Additive | 0 ± .5% | .4-.775 ± .5% |
| Wax Emulsion | 39.9 ± .5% | 39.9 ± .5% |
| Potash | 1.25 ± .5% | 1.25 ± .5% |
| Retarder | 0.1 ± .5% | 0.1 ± .5% |

*In these samples, BMA is used as the accelerator. 50% of the weight of BMA is starch. While BMA contains starch, the reduced levels of starch discussed below only refers to reducing the starch that is added separately to the slurry and does no refer to BMA or any other additive that may contain starch.

In addition to stucco, starch, pulp paper, pulp water and potash being added to the stucco slurry composition, the slurry composition contains an accelerator, such as BMA (produced by National Gypsum Company) and a dispersant, such as Diloflow (produced by Geo Chemicals), Gypflow (produced by Handy Chemicals) and Daxad (produced by Geo Chemicals). In this example the pulp water contains a retarder, such as, Proteinaceous Retarder (produced by National Gypsum Company), Accumer (produced by Rohm & Haas), and RA-77 (produced by Rhodia) and a sugar, such as dextrose. In this formulation, a retarder is present in the slurry in the amounts of about 1 lbs per 1,000 square feet and sugar is present in the slurry in the amount of about 2.31 lbs per 1,000 square feet. While specific examples of accelerators, dispersants, retarders, and sugars are disclosed, it will be appreciated that any number of accelerators, dispersants, retarders, and sugars can be used to produce the slurry compositions. It will be appreciated that the formulation of Table II was used at a specific plant and would need to be adjusted as needed to account for the quality of stucco used in other plants, the temperature of the water used at other plants, and other similar factors that may affect the quality of the produced wallboard.

The foam solution used in the creation of these exemplary slurry compositions had a weight of approximately 12.5 lbs/cubic foot to about 13.0 lbs/cubic foot; however, foam compositions having a weight between 8.0 and 14.0 lbs./cubic foot may also be used. Both ½ inch and ⅝ inch thick boards were produced from the above formulas at line speeds of about 205.4 feet/minute for ½ inch thick boards and about 175 feet/minute for ⅝ inch thick boards. The boards were tested to determine if the reduction in starch adversely impacted the compressive strength (nail pull strength) of the produced wallboard. Table III shows a series of samples prepared using the above formulations with varying amounts of starch and varying amounts of the starch reducing additive. In each sample, the starch reducing additive comprises the silicone hybrid polymer known as YC-50.

TABLE III
Nail Pull Strength of Control Samples from Tables I and II

| Thickness | Additive | Starch | Nail Pull |
|---|---|---|---|
| (inches) | lbs/msf | lbs/msf | Strength |
| ½ | 0 | 14 | 67.04 |
| ½ | 0 | 14 | 66.56 |
| ½ | 0 | 14 | 66.33 |
| ½ | 0 | 14 | 67.77 |
| ½ | 0 | 14 | 67.34 |
| ½ | 0 | 14 | 67.02 |
| ½ | 0 | 14 | 64.32 |
| ½ | 0 | 14 | 64.60 |
| ⅝ | 0 | 9 | 84.52 |
| ⅝ | 0 | 9 | 85.90 |

TABLE IV
Nail Pull Strength of Test Samples from Tables I and II

| Thickness | Additive | Starch | Nail Pull |
|---|---|---|---|
| (inches) | lbs/msf | lbs/msf | Strength |
| ½ | .409 | 12 | 67.05 |
| ½ | .409 | 12 | 68.58 |
| ½ | .409 | 10 | 67.77 |
| ½ | .409 | 10 | 68.77 |
| ½ | .4 | 10 | 69.90 |
| ½ | .5 | 10 | 67.50 |
| ½ | .5 | 9 | 67.60 |
| ½ | .5 | 9 | 68.80 |
| ½ | .5 | 9 | 66.50 |
| ½ | .5 | 9 | 70.60 |
| ½ | .5 | 9 | 65.50 |
| ½ | .5 | 9 | 74.40 |
| ½ | .5 | 9 | 67.30 |
| ½ | .4 | 8 | 69.30 |
| ½ | .4 | 8 | 67.80 |
| ½ | .664 | 8 | 66.30 |
| ½ | .775 | 8 | 67.80 |
| ½ | .775 | 8 | 70.20 |
| ½ | .644 | 7 | 63.50 |
| ½ | .644 | 7 | 64.00 |
| ½ | .409 | 6 | 67.74 |
| ½ | .409 | 6 | 67.17 |
| ½ | .409 | 6 | 64.11 |
| ⅝ | 0 | 9 | 84.52 |
| ⅝ | 0 | 9 | 85.90 |
| ⅝ | .409 | 7 | 89.83 |
| ⅝ | .409 | 6 | 86.20 |
| ⅝ | .4 | 6 | 83.65 |
| ⅝ | .4 | 6 | 91.17 |
| ⅝ | .4 | 6 | 86.31 |
| ⅝ | .4 | 6 | 86.62 |
| ⅝ | .4 | 5 | 87.92 |
| ⅝ | .4 | 5 | 86.17 |

As shown by comparing the nail pull strength of the test samples in Table IV to the control samples in Table III, all of the test samples, despite the reduced level of starch used, still maintained nail pull strength measurements comparable to or that exceeded the nail pull strength of the control samples.

Table V shows an exemplary slurry formulation in grams for ½ inch thick lab test boards that were used to compare lab control samples (normal starch levels and no additive) with lab test samples that have a reduced amount of starch and a styrene acrylic copolymer or acrylic hybrid copolymer additive. It is understood by one skilled in the art that these lab test formulations are increased proportionately to produce dry boards with weights around 1,400 and 1,700 pounds per 1,000 square feet for a ½ inch thick wallboard. While the slurry formulation of Table V was used in the lab environment where external factors can be controlled, it will be appreciated that the formulation can be used in the plant environment and can be adjusted as needed to account for the quality of stucco used, the temperature of the water used, and other similar factors that may affect the quality of the produced wallboard.

TABLE V
Slurry Formulation for ½ Inch Thick Board

| | Control | Samples |
|---|---|---|
| Materials | (g) | (g) |
| Stucco | 870 | 870 |
| Foam Water | 275 | 275 |
| Gauging Water | 930 | 930 |
| Paper | 1.50 | 1.50 |
| Pulp Water | 443.40 | 443.40 |
| Surfactant | .5-.8/280 g of H₂O | .5-.8/280 g of H₂O |
| Water dispersant | 3.00 | 3.00 |
| Starch | 11.7 | 0-9 |
| Accelerator* | 2.50 | 2.50 |
| Additive | 0 | .4-2.00 |
| Sugar | 1.00 | 1.00 |
| Potash | 0.25 | 0.25 |
| Retarder | 0.4 | 0.4 |

In order to determine if the reduction in starch adversely impacts the overall strength and paper to core bond of the produced wallboard, lab test boards were prepared to compare the compressive strength (nail pull strength) and the strength of the paper to core bond (percent of bond failure) of the lab test board to the lab control boards. Table VI shows the nail pull strength and percent of bond failure for several lab control samples. Table VII shows a series of lab test samples prepared using the above formulations with varying amounts of starch and varying amounts of the starch reducing additive. In each lab test board, the starch reducing additive comprises the silicone hybrid polymer known as YC-50.

TABLE VI
Nail Pull Strength and Bond Failure for Control Samples

| | | | | | | 2 Hr |
|---|---|---|---|---|---|---|
| | | | Nail Pull | Nail Pull | Nail Pull | Humidified |
| Board | Additive | | Strength | Strength | Strength | Bond |
| Weight | (g) | Starch (g) | (Avg.) | (Std. Dev.) | (Corrected) | (% Failure) |
| 1620 | 0 | 11.7 | 77.07 | 5.52 | 81.43 | 2.08 |
| 1650 | 0 | 11.7 | 65.58 | 2.89 | 70.63 | 15.63 |
| 1680 | 0 | 11.7 | 67.34 | 3.44 | 69.63 | 30.21 |
| 1630 | 0 | 11.7 | 63.34 | 2.41 | 69.45 | 35.42 |
| 1620 | 0 | 11.7 | 57.78 | 5.68 | 64.76 | 46.88 |
| 1600 | 0 | 11.7 | 65.28 | 3.09 | 72.59 | 9.38 |
| 1570 | 0 | 11.7 | 63.74 | 4.18 | 72.47 | 3.13 |
| 1620 | 0 | 11.7 | 63.56 | 3.81 | 69.40 | 21.88 |
| 1630 | 0 | 11.7 | 59.34 | 4.72 | 65.70 | 43.75 |
| 1620 | 0 | 11.7 | 67.45 | 1.80 | 73.19 | 32.00 |
| 1595 | 0 | 11.7 | 62.63 | 1.99 | 69.86 | 34.00 |
| 1620 | 0 | 11.7 | 65.65 | 3.71 | 71.54 | 8.00 |
| 1615 | 0 | 11.7 | 68.64 | 5.49 | 74.85 | 36.00 |
| 1660 | 0 | 11.7 | 64.12 | 3.20 | 67.21 | 13.54 |
| 1670 | 0 | 11.7 | 67.54 | 4.97 | 69.78 | 16.67 |
| 1640 | 0 | 11.7 | 62.87 | 3.31 | 67.23 | 16.67 |
| 1640 | 0 | 11.7 | 67.84 | 4.72 | 72.30 | 4.17 |

TABLE VII
Nail Pull Strength and Bond Failure for Test Samples

| | | | | | | 2 Hr |
|---|---|---|---|---|---|---|
| | | | Nail Pull | Nail Pull | Nail Pull | Humidified |
| Board | Additive | | Strength | Strength | Strength | Bond |
| Weight | (g) | Starch (g) | (Avg.) | (Std. Dev.) | (Corrected) | (% Failure) |
| 1530 | .50 | 7.0 | 70.57 | 4.56 | 80.69 | 0 |
| 1640 | .50 | 7.0 | 77.95 | 3.56 | 80.97 | 0 |
| 1610 | .70 | 5.0 | 74.50 | 4.27 | 79.71 | 0 |
| 1600 | .70 | 5.0 | 74.37 | 3.57 | 79.92 | 0 |
| 1595 | .50 | 7.0 | 65.82 | 5.69 | 71.49 | 73.96 |
| 1545 | .50 | 7.0 | 66.22 | 3.23 | 75.57 | 47.92 |
| 1550 | .70 | 5.0 | 65.22 | 5.61 | 74.29 | 45.83 |
| 1540 | .70 | 5.0 | 67.30 | 4.15 | 76.62 | 21.88 |
| 1650 | .70 | 5.0 | 77.89 | 7.06 | 78.59 | 0 |
| 1670 | .70 | 5.0 | 79.29 | 7.22 | 79.07 | 0 |
| 1640 | .70 | 5.0 | 85.55 | 4.99 | 87.07 | 0 |
| 1645 | .70 | 5.0 | 83.47 | 11.62 | 84.66 | 0 |
| 1705 | 1.25 | 1.0 | 60.47 | 4.09 | 61.59 | 32.29 |
| 1740 | 1.25 | 1.0 | 63.95 | 3.69 | 63.17 | 20.83 |
| 1720 | 1.25 | 1.0 | 58.66 | 4.58 | 58.83 | 17.71 |
| 1660 | 1.25 | 1.0 | 52.94 | 7.38 | 56.65 | 14.58 |
| 1630 | 1.00 | 1.0 | 64.29 | 2.82 | 69.40 | 6.25 |
| 1630 | 1.00 | 1.0 | 63.05 | 2.52 | 67.95 | 0 |
| 1580 | 1.50 | 1.0 | 59.31 | 2.83 | 67.35 | 0 |
| 1565 | 1.50 | 1.0 | 59.05 | 2.63 | 68.05 | 0 |
| 1665 | .40 | 5.0 | 67.05 | 2.76 | 70.03 | 0 |
| 1590 | .40 | 5.0 | 60.53 | 3.47 | 68.23 | 5.21 |
| 1590 | .40 | 5.0 | 61.09 | 4.80 | 68.54 | 1.04 |
| 1590 | .40 | 5.0 | 58.61 | 3.28 | 66.11 | 6.25 |
| 1630 | .40 | 5.0 | 68.65 | 2.75 | 73.04 | 0 |
| 1610 | .40 | 5.0 | 62.80 | 3.16 | 68.62 | 0 |
| 1610 | .40 | 5.0 | 63.35 | 4.32 | 68.97 | 0 |
| 1640 | .40 | 5.0 | 59.68 | 3.32 | 65.06 | 13.54 |
| 1605 | .40 | 5.0 | 60.49 | 2.50 | 67.58 | 12.50 |
| 1615 | .40 | 5.0 | 57.69 | 4.69 | 64.20 | 44.79 |
| 1580 | .40 | 5.0 | 58.22 | 3.63 | 66.94 | 36.46 |
| 1600 | .40 | 5.0 | 62.06 | 2.25 | 69.08 | 0 |
| 1540 | .40 | 5.0 | 55.05 | 4.92 | 64.96 | 0 |
| 1530 | .40 | 5.0 | 56.66 | 2.44 | 67.46 | 0 |
| 1540 | .40 | 5.0 | 59.06 | 4.44 | 68.63 | 0 |
| 1580 | .40 | 5.0 | 60.92 | 2.11 | 68.91 | 6.25 |
| 1540 | .40 | 5.0 | 54.76 | 3.59 | 65.79 | 35.42 |
| 1550 | .40 | 5.0 | 57.69 | 3.87 | 68.65 | 54.17 |
| 1550 | .40 | 5.0 | 56.44 | 3.79 | 66.54 | 13.54 |
| 1565 | .40 | 5.0 | 57.89 | 3.04 | 67.33 | 6.25 |
| 1580 | .40 | 5.0 | 60.76 | 1.84 | 68.75 | 3.13 |
| 1565 | .40 | 5.0 | 58.27 | 1.55 | 67.36 | 22.92 |
| 1565 | .40 | 5.0 | 54.57 | 4.92 | 63.22 | 29.17 |
| 1590* | .40 | 9.0 | 64.51 | 3.88 | 72.31 | 0 |
| 1620* | .40 | 9.0 | 62.07 | 2.39 | 68.01 | 1.04 |
| 1605* | .40 | 9.0 | 65.20 | 2.53 | 71.69 | 14.58 |
| 1590* | .40 | 9.0 | 68.48 | 2.97 | 76.28 | 8.33 |
| 1600* | .40 | 9.0 | 64.93 | 2.95 | 71.94 | 1.04 |
| 1590* | .40 | 9.0 | 63.03 | 1.55 | 69.93 | 8.33 |
| 1625* | .40 | 9.0 | 66.76 | 2.64 | 71.72 | 6.25 |
| 1560* | .40 | 9.0 | 60.82 | 4.92 | 69.59 | 1.04 |
| 1600* | .40 | 7.0 | 67.15 | 3.13 | 73.46 | 2.08 |
| 1530* | .40 | 7.0 | 60.03 | 3.42 | 71.11 | 0 |
| 1580* | .40 | 7.0 | 62.78 | 3.42 | 70.72 | 7.29 |
| 1575* | .40 | 7.0 | 62.04 | 2.30 | 70.84 | 2.08 |

*Samples were prepared by also adding .2 g of sodium trimetaphosphate (“STMP”) to the slurry.

Each sample listed in Tables VI and VII represent the average of ten test data points taken from a single lab test board. The standard deviation for the ten samples taken is listed in the Tables. The nail pull strength was measured for each sample and then the nail pull strength was then calculated as if the board weighed 1675 pounds per 1,000 square feet (“Nail Pull Strength (Corrected)”). As shown by comparing the nail pull strength of the test samples in Table VII to the control samples in Table VI, all of the lab test samples still maintained nail pull strength measurements comparable to or that exceeded the nail pull strength of the lab control samples despite the reduced amount of starch used. Similarly, the lab test samples exhibited paper to core bonds of comparable strength to or that exceeded the strength of the paper to core bonds of the lab control samples, despite the reduced amount of starch used.

While methods of manufacturing wallboard and the resulting wallboard have been described in detail with reference to certain exemplary embodiments thereof, such are offered by way of non-limiting examples, as other versions are possible. It is anticipated that a variety of other modifications and changes will be apparent to those having ordinary skill in the art. For example, the use of styrene acrylic copolymers or acrylic hybrid copolymers can be used with all types of gypsum wallboard with different formulations. All such modifications and changes are intended to be encompassed within the spirit and scope of the invention as defined by the following and any later added claims.

1. A gypsum wallboard having a core composition comprising:
a. calcium sulfate hemihydrate;
b. water;
c. a starch in the amounts of 0 to about 12 pounds per 1,000 manufacturing square feet of the composition; and
d. at least one styrene acrylic copolymer or acrylic hybrid copolymer in the amount of about 0.25 pounds per 1,000 manufacturing square feet to about 1 pound per 1,000 manufacturing square feet of the composition.

2. A gypsum wallboard according to claim 1, wherein the board has approximately the same or improved nail pull strength as a board made by a similar composition having no styrene acrylic copolymer or acrylic hybrid copolymer and having at least 2 pounds per 1,000 manufacturing square feet more starch.

3. A paper-faced gypsum wallboard according to claim 1, wherein the board has approximately the same or improved humidified paper core bond integrity as a board made by a similar composition having no styrene acrylic copolymer or acrylic hybrid copolymer and having at least 2 pounds per 1,000 manufacturing square feet more starch.

4. A gypsum wallboard according to claim 1, wherein the acrylic hybrid copolymer is a silicone acrylic hybrid copolymer.

5. A method for producing a wallboard core slurry, the method comprising the steps of:
providing a mixer with a hopper connected to the mixer and a pulp waterline connected to the mixer;
adding stucco and at least one other dry ingredient to the mixer through the hopper;
adding pulp water and at least one other wet ingredient to the mixer through the pulp waterline;
adding a natural polymer in the amount of 0 to about 12 pounds per 1,000 manufacturing square feet of slurry;
adding at least one styrene acrylic copolymer or acrylic hybrid copolymer; and
forming a gypsum slurry by mixing the stucco, the at least one other dry ingredient, the pulp water, the at least one other wet ingredient, the natural polymer, and the at least one styrene acrylic copolymer or acrylic hybrid copolymer in the mixer.

6. The method of claim 5 wherein the mixer further comprises a gauging waterline and the method further comprises the step of adding gauging water to the mixer and forming the gypsum slurry by mixing the gauging water with the stucco, the at least one other dry ingredient, the pulp water, the at least one other wet ingredient, the natural polymer, and the at least one styrene acrylic copolymer or acrylic hybrid copolymer in the mixer.

7. The method of claim 6 wherein the step of adding the at least one styrene acrylic copolymer or acrylic hybrid copolymer comprises pumping the at least one styrene acrylic copolymer or acrylic hybrid copolymer into the gauging waterline so that the at least one styrene acrylic copolymer or acrylic hybrid copolymer is added to the mixer with the gauging water.

8. The method of claim 5 wherein the mixer further comprises a foam waterline and the method further comprises the step of adding foam to the mixer and forming the gypsum slurry by mixing the foam with the stucco, the at least one other dry ingredient, the pulp water, the at least one other wet ingredient, the natural polymer, and the at least one styrene acrylic copolymer or acrylic hybrid copolymer in the mixer.

9. The method of claim 8 wherein the step of adding the at least one styrene acrylic copolymer or acrylic hybrid copolymer comprises pumping the at least one styrene acrylic copolymer or acrylic hybrid copolymer into the foam waterline so that the at least one styrene acrylic copolymer or acrylic hybrid copolymer is added to the mixer with the foam.

10. The method of claim 5 wherein the step of adding the at least one styrene acrylic copolymer or acrylic hybrid copolymer comprises pumping the at least one styrene acrylic copolymer or acrylic hybrid copolymer into the pulp waterline so that the at least one styrene acrylic copolymer or acrylic hybrid copolymer is added to the mixer with the pulp water.

11. The method of claim 5, wherein the natural polymer is a starch.

12. The method of claim 5, wherein the styrene acrylic copolymer or acrylic hybrid copolymer is added in the amount of about 0.25 pounds per 1,000 manufacturing square feet to about 1 pound per 1,000 manufacturing square feet of slurry.

13. The method of claim 5, further comprising forming and setting the slurry to produce a gypsum wallboard, wherein the board has approximately the same or improved nail pull strength as a board made by a similar method without adding styrene acrylic copolymer or acrylic hybrid copolymer and adding at least 2 pounds per 1,000 manufacturing square feet more natural polymer.

14. The method of claim 5, further comprising forming and setting the slurry to produce a paper-faced gypsum wallboard, wherein the board has approximately the same or improved humidified paper core bond integrity as a board made by a similar method without adding styrene acrylic copolymer or acrylic hybrid copolymer and adding at least 2 pounds per 1,000 manufacturing square feet more natural polymer.

15. The method of claim 5, wherein the at least one styrene acrylic copolymer or acrylic hybrid copolymer is a silicone acrylic hybrid copolymer.
